(19) United States
(12) Patent Application Publication
(10) Pub. No.: US 2003/0216926 A1
(43) Pub. Date: Nov. 20, 2003

(54) Method for guiding a business after an initial funding state to an initial public offering readiness state

(76) Inventors: Chris Scotto, Weddington, NC (US); Greg Boyer, Atlanta, GA (US); Robert Hope, Herndon, VA (US); Maureen Krezmien, Seven Fields, PA (US); Andrew Hopkins, Dallas, TX (US)

Correspondence Address: MORRISON & FOERSTER LLP, 425 MARKET STREET, SAN FRANCISCO, CA, 94105-2482, US

(21) Appl. No.: 09/938,328

(22) Filed: Aug. 23, 2001

(51) Int. Cl. G06F 17/60

(52) U.S. Cl. 705/1; 705/7

(57) ABSTRACT

A system and method for guiding a business after an initial funding state to an initial public offering (“IPO”) readiness state. A first stage approach launches the business and a second stage approach is performed for at least one of maturing the business and guiding the business to an IPO readiness state. The first stage approach readies the company for launch, focusing on moving quickly to market, defining expectations, attracting customers, building a brand, building alliances, creating disposable solutions, and investing resources. The second stage approach grows and matures the company, focusing on capturing the market, expanding expectations, retaining customers, attracting new customers, expanding alliances, creating effective solutions, and making money.

### FIELD OF THE INVENTION

This invention relates generally to methods for managing businesses and specifically to methods for guiding businesses after an initial finding state to an initial public offering readiness state.

### BACKGROUND OF THE INVENTION

Businesses, and particularly e-commerce start-up companies, often launch less than optimal business solutions. Companies in beginning stages face unique challenges. Moving quickly to market is usually critical, but the companies possess limited resources. The uncertainty of the new market requires the companies to be flexible. The need for sharp growth requires the companies to be scalable. The companies must focus on launching the business, while addressing rapidly escalating requirements.

Unfortunately, many companies encounter common pitfalls as they confront these challenges. Some lack a clear value proposition. Others have poorly defined operating strategies and business models. Many are unable to focus beyond the development and implementation of a website that showcases a new technology, and therefore leave personnel and organizational issues unresolved. Frequently, the companies' managers focus on design before planning, and therefore fall victim to muddled priorities. Financial managers often authorize expensive purchase decisions too early and without justification. In general, even when these companies are working toward an effective launch, they fail to consider whether they can become profitable or even remain stable after the launch.

These substandard business solutions routinely delay the companies' initial public offering (“IPO”) readiness. It has been estimated that the majority of all online projects will fail, because they rely too heavily on new technology and ignore traditional business planning and strategy. In many cases, even the companies themselves do not fully understand the technologies behind the new e-commerce solutions.

Therefore, there is a need for enhanced business development approaches for companies, such as e-commerce start-ups, that increase the speed at which the companies get to market by increasing the flexibility and scalability of the companies' solutions. The companies' risks of arriving late to market should be effectively balanced against the implementation of a marginal solution. There is also a need for maximizing the companies' market valuations by effectively aligning the companies' short term and long term performance and priorities. The companies' business models should be designed and built to effectively deliver the companies' value propositions.

### SUMMARY OF THE INVENTION

The invention provides a method for guiding a business after an initial funding state to an IPO readiness state. In an embodiment, a method of the invention includes performing a first stage approach for launching the business and performing a second stage approach for least one of maturing the business and guiding the business to an initial public offering readiness state. The method can be used to guide a company, such as an e-commerce start-up, after the company has already identified a value proposition and a business strategy, developed a business plan, and received initial venture capital funding. When the company is, for example, an e-commerce start-up, these activities are effectively performed and completed in a compressed timeframe and in partial concurrence. The end of the first stage approach in some embodiments may overlap the beginning of the second stage approach. For example, the first stage approach may occur over a first stage approach timeframe that preferably lasts five weeks, and the second stage approach may occur over a second stage approach timeframe that preferably lasts five weeks. This partially concurrent multi-stage design enables the launch decisions in the first stage approach to serve as building blocks for the growth and extension in the second stage approach, and serves to compress the time frame required for reaching maturity and/or reaching an IPO readiness state.

The method can be implemented within three primary focus areas, where the company “thinks big”, “starts small”, but is prepared to “scale rapidly”. The first stage approach can be used to guide a company through and among the first focus area, “Think Big”, and the second focus area, “Start Small”. Similarly, the second stage approach can be used to guide the company through and among the second focus area, “Start Small”, and the third focus area, “Scale Rapidly”. The first stage approach readies the company for launch, focusing on moving quickly to market, defining expectations, attracting customers, building a brand, building alliances, creating disposable solutions, and investing resources. The second stage approach grows and matures the company, focusing on capturing the market, expanding expectations, retaining customers, attracting new customers, expanding alliances, creating effective solutions, and making money. These focus areas effect the development of solutions that attract and retain customers, and the integration of personnel and infrastructure solutions, that enable the venture's value proposition to be economically executed quickly and with the flexibility to respond to changes in the market.

In one aspect, performing the first stage approach includes reviewing a business strategy, defining an operating vision, developing a first stage operating strategy, developing at least one first stage priority, developing at least one first stage architecture for implementing the first stage strategy to achieve the first stage priority, developing a plan for launching the business using the first stage architecture, and launching the business. These activities present a focused and tightly integrated approach to delivering the business and performance capabilities that are necessary for launching the business. They establish sound foundations through a value-driven approach that imparts value to stakeholders, customers, partners, and the venture itself. The top-down aspect of the approach designs and builds the venture in a manner driven by financial priorities, strategic concerns, and value considerations.

Performing the first stage approach can further include reaffirming an economic case for the business while developing the business launch plan, developing a capability simulation demonstration for testing the first stage architecture while developing the architecture, and managing post-launch business operations.

With regard to completing the first stage approach in a compressed timeframe and in partial concurrence, reviewing the business strategy and defining the operating vision can be performed during a first week of a first stage approach timeframe, developing the first stage operating strategy and developing the first stage priority can be performed during a second week of the timeframe, developing the first stage architecture can be performed from the second week to a fourth week of the timeframe, developing the business launch plan can be performed from the fourth week to a fifth week of the timeframe, and launching the business is preferably performed after the fifth week.

In another aspect, the second stage approach matures the business and performing the second stage approach includes reviewing at least one result of performing the first stage approach; evaluating the first stage operating strategy in light of the result review; developing, based on the first stage operating strategy evaluation, a second stage operating strategy and at least one second stage priority; evaluating the first stage architecture in light of the second stage operating strategy; developing, based on the first stage architecture evaluation, at least one second stage architecture for implementing the second stage operating strategy to achieve the second stage priority; developing a plan for launching a second stage capability using the second stage architecture; and launching the capability.

Performing the second stage approach can further include reaffirming an economic case for the business while developing the capability launch plan and developing a process simulation demonstration for testing the second stage architecture while developing the architecture.

With regard to completing the second stage approach in a compressed timeframe and in partial concurrence, reviewing the result, evaluating the first stage operating strategy, and developing the second stage operating strategy and the second stage priority can be performed during a first week of a second stage approach timeframe; evaluating the first stage architecture can be performed during a second week of the timeframe; developing the second stage architecture can be performed from the second week to a fourth week of the timeframe; developing the capability launch plan can be performed from the fourth week to a fifth week of the timeframe, and launching the capability can be performed after the fifth week.

In yet another aspect, the second stage approach guides the business to an initial public offering readiness state and performing the second stage approach includes defining at least one operational performance target that when achieved by the business will evidence an IPO readiness state of the business; reviewing at least one operation of the business in light of the target; determining, based on the business operation review, a second stage operating strategy that when followed will achieve the target; evaluating the first stage architecture in light of the second stage operating strategy; developing, based on the evaluation, at least one second stage architecture for implementing the second stage operating strategy to achieve the target; developing a plan for launching a second stage capability using the second stage architecture; and launching the capability.

Performing the second stage approach in this aspect can further include reaffirming an economic case for the business while developing the capability launch plan and developing a business simulation demonstration for testing the second stage architecture while developing the architecture.

With regard to completing the second stage approach in this aspect in a compressed timeframe and in partial concurrence, defining the target and reviewing the business operation and determining the second stage operating strategy can be performed during a first week of a second stage approach timeframe; evaluating the first stage architecture and developing the second stage architecture can be performed from a second week of the timeframe to a fourth week of the timeframe; developing the capability launch plan can be performed from the fourth week to a fifth week of the timeframe; and launching the capability can be performed after the fifth week.

### BRIEF DESCRIPTION OF THE DRAWINGS

FIG. 1 is a chart illustrating a prior art method of guiding a business to an IPO readiness state, wherein three focus areas have a prior art order and length.

FIG. 2 is a diagram showing an exemplary method of the invention as reordering and compressing the length of the focus areas of FIG. 1.

FIG. 3 is a diagram showing an exemplary method of the invention highlighting a first stage approach of the method.

FIG. 4 is a flowchart illustrating activities of a first stage approach of an exemplary method of the invention within a first stage approach timeframe.

FIG. 5 is a diagram showing an exemplary method of the invention highlighting a second stage approach of the method.

FIG. 6 is a flowchart illustrating activities of a second stage approach of an exemplary method of the invention within a second stage approach timeframe.

FIG. 7 is a flowchart illustrating activities of an alternate second stage approach of an exemplary method of the invention within an alternate second stage approach timeframe.

### DETAILED DESCRIPTION OF THE INVENTION

In an embodiment, a method of the invention for guiding a business after an initial funding state includes performing a first stage approach for launching the business and performing a second stage approach for at least one of maturing the business and guiding the business to an initial public offering readiness state. The method may be used to guide a company, such as an e-commerce start-up, after the company has already identified a value proposition and a business strategy, developed a business plan, and received initial venture capital funding.

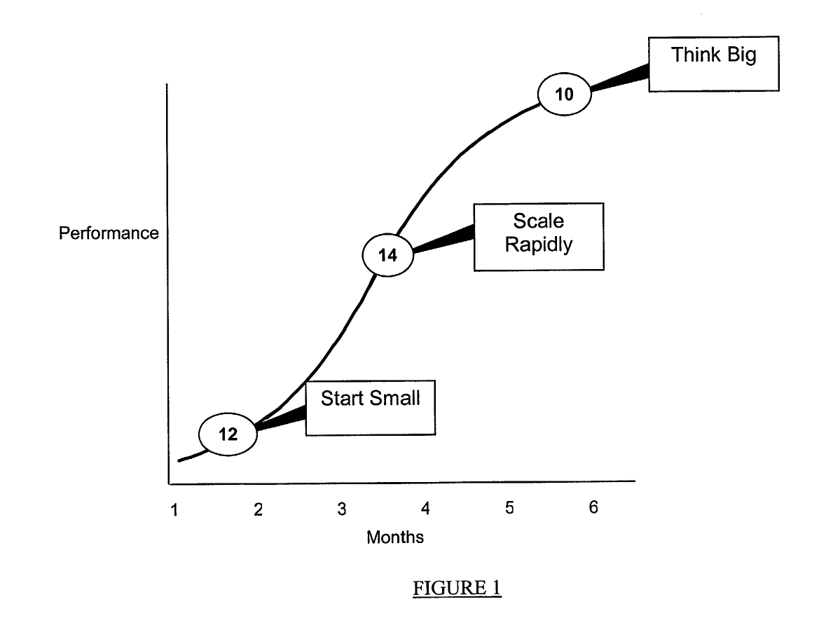

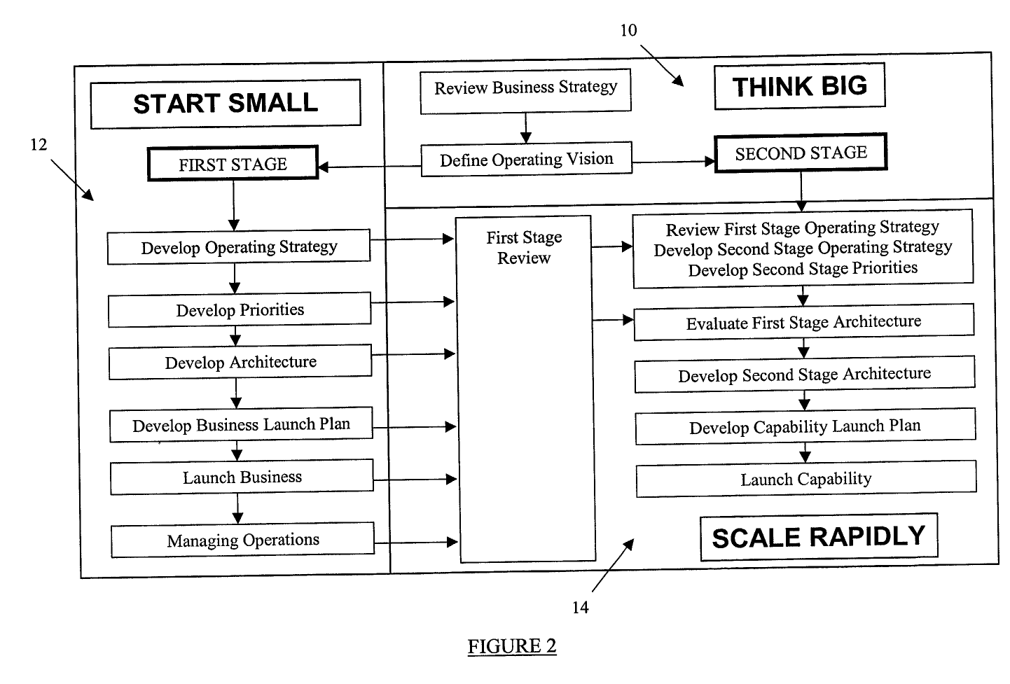

FIG. 1 illustrates a prior art method of guiding a business to an IPO readiness state, wherein three focus areas have a prior art order and length, and FIG. 2 illustrates an exemplary method of the invention as reordering and compressing the length of the focus areas of FIG. 1. The first of the three focus areas, “Think Big”, is indicated at 10 and represents an area of focus within which a company, for example, develops a business vision for meeting the needs of a target market, develops a value proposition to meet those needs, develops a vision for establishing a venture to deliver the value proposition, identifies key players for the venture and desired third party alliances, and identifies objectives that when met will cause the venture to be successful.

The second of the three focus areas, “Start Small”, is indicated at 12 and represents an area of focus within which the company, for example, seeks to minimize the cost of launching the venture, minimize the risk of disrupting existing business priorities, understand and weigh the business priorities (e.g., speed vs. offering vs. cost vs. risk), define success factors (e.g., number of users vs. number of customers vs. revenue vs. profit), define launch minimums and build accordingly, prepare for unexpected market events (e.g., competition and/or success), position the venture for future operation (e.g., begin to acquire alliances, infrastructure and/or technology), and build corporate knowledge and experience.

The third of the three focus areas, “Scale Rapidly”, is indicated at 14 and represents an area of focus within which the company, for example, refines its value proposition (e.g., in response to external and internal events); identifies the need for new and enhanced capabilities; redefines its business model and architecture; leverages its current technology, infrastructure and/or facility investments; builds new infrastructure and technology capabilities; scales quickly to protect existing customers; acquires and retains customers through new value propositions, new products and services, increased speed and excellent execution; and plans for and achieves a financial return on investment.

Within these focus areas, the company “thinks big”, “starts small”, but is prepared to “scale rapidly”.

The first stage approach can be used to guide a company through and among the first focus area, “Think Big”, and the second focus area, “Start Small”. Similarly, the second stage approach can be used to guide the company through and among the second focus area, “Start Small”, and the third focus area, “Scale Rapidly”.

Each of the first and second stage approaches has defining characteristics. For example, the first stage approach readies the company for launch by focusing on moving quickly to market, defining expectations, attracting customers, building a brand, building alliances, creating disposable solutions, and investing resources. More specifically, the company identifies priorities and focuses resources on creating capabilities that are critical for launching successfully with a competitive advantage. The company also defines the business outcomes that are needed for launch (e.g., the customer experience, the investor expectations, the financial results, and the infrastructure development). Without wasting effort on secondary priorities, the company ensures that the business can fulfill the customer and alliance partner expectations. Further, the company delays expensive decisions and outsources functions whenever possible. The specific ways in which the company is to accomplish these generally described tasks will be evident from the more detailed discussion that follows of the particular activities of the first stage approach.

The speed and resource constraints during the first stage approach mandate a first stage architecture that includes legacy and disposable components. Such components are established as the company outsources early and insources slowly. Renting or leasing property and equipment enables the company to maintain flexibility because equipment that becomes unuseful or outdated can be replaced at a minimum cost. Using disposable and/or partial solutions accomplishes tasks without wasting the resources that would have otherwise been used to create and maintain solutions that accomplish more than is needed and for a longer period of time than is needed. Partnerships and alliances enable the company to create and maintain adaptability and minimize risk because building in-house capabilities that could otherwise be accomplished by a partner or through an alliance strains human and capital resources and prevents the company from being able to shift resources quickly to other efforts as unexpected needs arise. Temporary solutions, applications, organization structures and accountabilities are implemented in lieu of permanent counterparts so that if the focus of the company must shift, these features can adapt quickly. The company monitors key results (both internal and external) to enable it to simultaneously operate, address unexpected complications and improve. Again, the specific ways in which the company is to accomplish these generally described tasks will be evident from the more detailed discussion that follows of the particular activities of the first stage approach.

The second stage approach grows and matures the company by focusing on capturing the market, expanding expectations, retaining customers, attracting new customers, expanding alliances, creating effective solutions, and making money. More specifically, the operating environment in which the second stage approach is implemented provides a stable and robust platform for continued expansion and growth. Growth is encountered on multiple levels: the company adds new product and service offerings; demand increases rapidly and customer requirements expand and mature; the company identifies and takes advantage of market opportunities while retaining focus; the company addresses the expectations and requirements of business partners and alliances; and venture capitalists, investors and other stakeholders are rewarded by the company's financial returns and increased market share. The specific ways in which the company is to accomplish these generally described tasks will be evident from the more detailed discussion that follows of the particular activities of the second stage approach.

Performing the first stage approach includes reviewing a business strategy, defining an operating vision, developing a first stage operating strategy, developing at least one first stage priority, developing at least one first stage architecture for implementing the first stage strategy to achieve the first stage priority, developing a plan for launching the business using the first stage architecture, and launching the business. These activities present a focused and tightly integrated approach to delivering the business and performance capabilities that are necessary for launching the business.

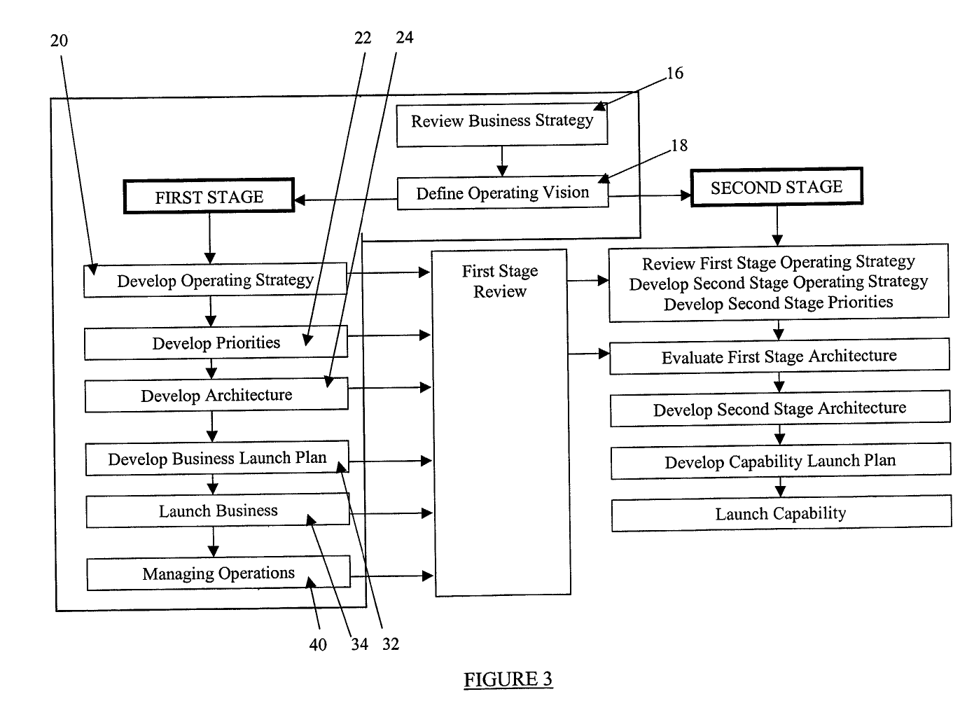

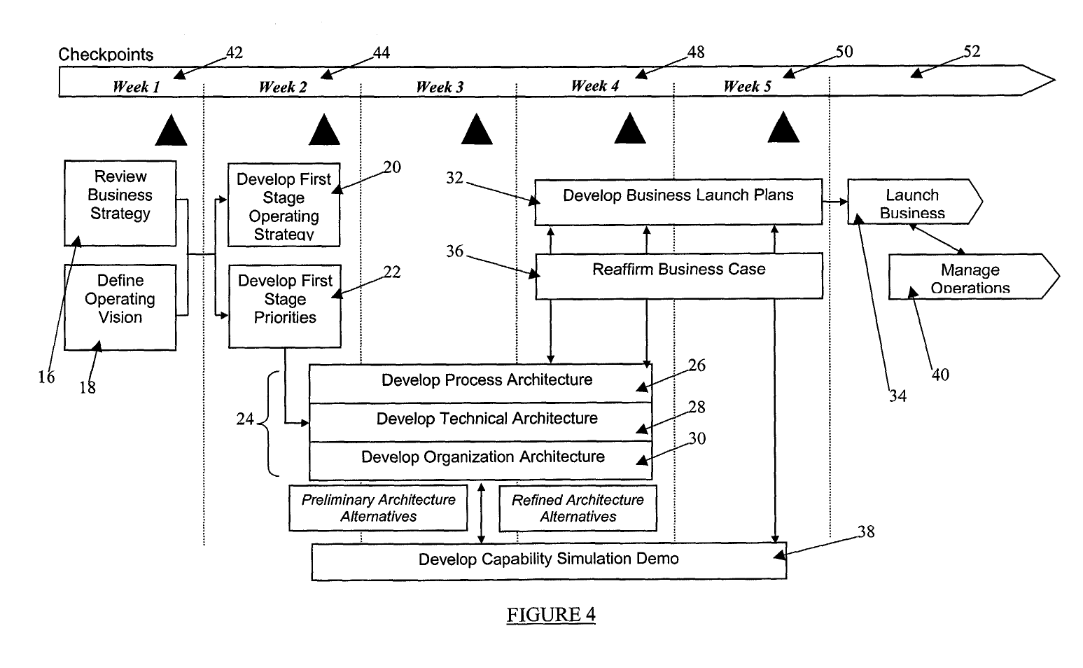

FIG. 3 illustrates an exemplary method of the invention highlighting a first stage approach, and FIG. 4 illustrates activities of the first stage approach within a first stage approach timeframe. When the company is, for example, an e-commerce start-up, the first stage approach activities can be effectively performed in the manner illustrated in FIG. 3 and can be effectively completed in a compressed timeframe and in partial concurrence in a manner illustrated in FIG. 4.

When reviewing the business strategy (indicated at 16), the company defines the target market space, the business strategy and the value proposition, as these tasks and task objects are readily understood by one having ordinary skill in the art. With regard to the market, exemplary specific determinations that are made include what the market opportunity is, what the target customer segments are, what the needs of the target customer segments are, where the venture sits in the value chain, what value proposition the venture offers, what products and services the venture can offer, what alliances are needed, and why customers will use the services and/or buy the products. With regard to the competitive environment, exemplary specific determinations that are made include who the existing competitors are, what the likely future competitive dynamics will be, and how the venture will stay ahead of the competition. With regard to economic considerations, exemplary specific determinations that are made include whether the venture will turn a profit and if so, how and when; what total level of investment is required and who will provide the funding; what the exit points and exit strategies are; and when the venture will go public and what must be demonstrated to potential investors in order to do so.

Key tasks that are accomplished when reviewing the business strategy include, for example, reviewing market analyses and defining the market opportunity; reviewing strategic and economic assumptions; reviewing customer segmentation and customer value propositions; defining the high-level customer experience; reviewing the alliance strategy; reviewing the competitive environment; reviewing the pricing model and financial projections; reviewing the branding strategy; confirming products, volumes, and geographies that are to be supported and ramped-up over time; identifying uncertainties and approaches for mitigating the uncertainties; and identifying and collecting simulation data.

Key deliverables that are created when reviewing the business strategy include, for example, a documented business strategy, high-level value analyses, a list of capabilities and KPIs that are to be added later, and simulation data.

When defining the operating vision (indicated at 18), the company defines the long-term operating model required to deliver the business strategy, the value proposition and the desired financial results, as this task and its objects are readily understood by one having ordinary skill in the art. With regard to performance targets, exemplary specific determinations that are made include what the critical performance targets are, what the estimated operating cost parameters are, and what the volume and capacity targets are. With regard to capabilities, exemplary specific determinations that are made include what the business model is (e.g., for external relationships), what the customer experience is, what the venture must be able to do to deliver the value proposition, what capabilities are needed, which capabilities will be built by the venture and operated in-house, what key operating features will enable the delivery of these capabilities (e.g., technology, people, facilities, processes and/or culture), what core competencies are required within the venture, how and when the venture will build these capabilities and competencies, and who will deliver the outsourced capabilities.

Key tasks that are accomplished when defining the operating vision include, for example, identifying the operational implications of the business strategy; defining and mapping required capabilities and interrelationships; defining primary and secondary capabilities; describing critical performance targets; describing a process management vision; describing an enabling technology vision; describing an enabling organization vision; describing an enabling human performance vision; describing an alliance and partnering vision; completing a high-level value analysis; and identifying assumptions, uncertainties, risks and mitigation strategies.

Key deliverables that are created when defining the operating vision include, for example, a high-level business model, a business capability map (e.g., a high-level architecture), key operating strategies and guiding principles, and pro-forma value analyses that are linked to capabilities and KPIs.

When developing a first stage operating strategy (indicated at 20), the company defines the business and operational requirements for launch and how the first stage approach activities will meet them, as these tasks and task objects are readily understood by one having ordinary skill in the art. With regard to customers, exemplary specific determinations that are made include what is needed to attract users and/or customers, what the venture must offer and/or provide to cause users and/or customers to return, how the venture will turn users into customers, how the venture can create barriers to entry for new entrants, what the end-to-end customer experience is at launch, and what services will be offered at launch. With regard to performance targets, exemplary specific determinations that are made include what level of finding must be achieved for launch and initial operations and what minimum performance levels are required at launch. With regard to capabilities, exemplary specific determinations that are made include what the business model looks like for launch, how the internal capabilities will need to operate to deliver the required performance levels, what the site requirements and characteristics are, and what the supporting infrastructure must deliver. With regard to partnering strategy (e.g., with suppliers, intermediaries and/or complementors), exemplary specific determinations that are made include what additional capabilities will need to be outsourced and how external capabilities will be outsourced and managed.

Key tasks that are accomplished when developing a first stage operating strategy include, for example, defining the customer experience at launch, defining the services and products that must be available at launch, identifying and defining the alliances that must be established by launch, defining the key performance metrics for launch, defining the launch build and run budgets, developing the launch operating guidelines and principles, refining the business capability model, developing the performance targets by capability and aligning budgets with capabilities (e.g., refining value analyses); defining site capabilities (e.g., “stickiness”), identifying the technology needed to support launch and post-launch operations, identifying initial organizational requirements and characteristics, and developing and refining preliminary capability blueprints.

Key deliverables that are created when developing a first stage operating strategy include, for example, lists of business objectives, guiding principles, end state features and characteristics that needed to achieve the objectives; documented business capability characteristics, outcomes, and preliminary blueprints; and technology priorities.

When developing the first stage priority (indicated at 22), the company identifies the priorities that are critical for the first stage approach activities and that are dictated by the first stage operating strategy, as this task and its objects are readily understood by one having ordinary skill in the art. With regard to activities related to the first stage approach, exemplary specific determinations that are made include what critical capabilities are necessary for success at launch and during the first stage approach operations; what the venture must perform correctly in the first stage approach; what capabilities can be done manually; how long, given volume and growth projections, can the venture operate with an interim solution; where the venture should focus its resources; how the venture can limit the investment needed for launch; what the major launch risks are; and what the venture's mitigation strategy is. With regard to activities related to the second stage approach (e.g., looking forward to what will be needed during the second stage approach), exemplary specific determinations that are made include how the business operational requirements will need to grow to achieve the long-term business and operating visions, what must be understood about the second stage approach requirements when designing and building the launch solution, how soon the venture must implement the second stage approach, what the lead time is for critical second stage approach decisions, what decisions can be postponed until after launch, what decisions must be made during the first stage approach to ensure that the venture is able to handle growth, and what future relationships and/or alliances must be put in place during the first stage approach.

Key tasks that are accomplished when developing the first stage priority include, for example, reviewing launch requirements (e.g., financial, performance, customer, and/or alliance requirements), defining launch-critical success factors, identifying capabilities critical to launch objectives, defining how launch will help achieve the critical success factors (e.g., by placing resources and attention on designing, building and operating), identifying secondary objectives, confirming which technology and/or alliance decisions must be made during the first stage approach, building initial simulation models to determine how long the initial launch infrastructure will support growth, identifying first stage approach decisions that require second stage approach requirements definition and input (e.g., consider delaying decisions by initially outsourcing capabilities), and using the operating vision to determine the second stage approach capabilities.

Key deliverables that are created when developing the first stage priority include, for example, launch-critical success factors, launch and initial operational priorities, and capabilities and/or decisions that require second stage approach requirements analysis.

When developing the first stage architecture for implementing the first stage strategy to achieve the first stage priority (indicated at 24), the architecture preferably includes a business architecture.

When developing the business architecture, the company defines how the venture interacts with customers and other external parties, as well as how the venture operates internally, as these tasks and task objects are readily understood by one having ordinary skill in the art. Exemplary specific determinations that are made include how the venture will deliver aspects of the defined customer experience; how the venture will ensure that relationships with third parties (e.g., partners and suppliers) operate as defined; how the business architecture will demonstrate the feasibility of the business strategy for stakeholders and/or investors; whether the venture will be able to operate at acceptable cost levels; how the first stage architecture will handle growth (e.g., does the venture have contingency plans for unexpected volumes); how the venture has maximized its ability to change what it offers customers and the way it operates if necessary; whether the venture's processes, organization and technologies are integrated across all capabilities; how the venture has integrated outsourced capabilities and how it will manage them; which components of the solution are disposable, which components are legacy and which components are evolutionary; what volumes and/or expectations the first stage approach architecture can handle; and what the plan and timeline are for building the second stage approach architecture.

Key tasks that are accomplished when developing the business architecture include, for example, confirming key inputs (e.g., business capability models, operating strategies, value analyses, and/or financial targets); confirming the business model and first stage architecture to ensure that all relationships and capabilities that must be built for launch are identified; confirming relationship and capability outcomes, KPIs and guiding principles; defining second stage approach requirements for legacy first stage approach architecture components (e.g., long-term decisions regarding, for example, culture, technology and/or alliances); designing the launch architecture (e.g., developing, the ability to support launch requirements and performance levels and/or developing, low-cost and flexible alternatives for disposable and evolutionary components); confirming that the first stage architecture supports the first stage approach ramp-up and capability simulations that validate the architecture.

Key deliverables that are created when developing the business architecture include, for example, the business model and the business architecture itself.

When developing the first stage architecture for implementing the first stage strategy to achieve the first stage priority (indicated at 24), the architecture preferably includes a component architecture that includes at least one of a process architecture, a technical architecture and an organization architecture.

When developing the component architecture, the company defines in detail each required business integration element, as this task and its objects are readily understood by one having ordinary skill in the art. With regard to a process architecture (indicated in FIG. 4 at 26), exemplary specific determinations that are made include what the business processes are; which processes are primary (e.g., high value) and which are secondary (e.g., support); what the key performance objectives, metrics and targets are for each process; how the processes will deliver the required performance; whether the venture has applied process excellence principles effectively; what dependencies exist between processes and how the venture has ensured that the processes are effectively integrated; and what the critical personnel and technology enablers are. With regard to a technical architecture (indicated at 28), exemplary specific determinations that are made include how the venture wants leaders and employees to behave, how the venture's organization supports the business model and objectives, how the venture is measuring team and/or individual performance to ensure the required outcomes and behaviors, and what skill and experience levels are required and how the venture is getting them. With regard to an organization architecture (indicated at 28), exemplary specific determinations that are made include how the website delivers the customer experience, what the supporting technology requirements are, how the technology solution meets those requirements, how the venture has integrated with third parties, and how the technology solution will handle unexpected volumes.

Key tasks that are accomplished when developing the component architecture include, for example, in addition to applicable tasks identified above with regard to developing the business architecture, confirming total design, architecture scope and priorities of the component architecture; ensuring that design teams are assigned; ensuring that design integration processes are in place and that designs remain integrated across capabilities and competencies (e.g., process, technology, organization and/or facility capabilities and competencies) throughout the design process; defining preliminary component architecture alternatives; developing criteria for selection; reviewing alternatives and selecting potential best fits; refining and completing architectures; validating the architectures with capability simulations; defining end-to-end architectures (e.g., for processes and/or technologies); defining capability blueprints and ensuring that the architecture provides the sufficient basis for detailed designing and building.

Key deliverables that are created when developing the component architecture include, for example, the process architecture, the technology architecture, the organization architecture, and capability blueprints.

When developing a plan for launching the business using the first stage architecture (indicated at 32), the company develops a plan that focuses on implementing a solution that delivers the business requirements in a pragmatic manner, as this task and its objects are readily understood by one having ordinary skill in the art. Exemplary specific determinations that are made include what the business launch plan is (e.g., regarding customer segments and/or marketing); what the operations release strategy must be to ensure the launch requirements are met, what projects must be completed to achieve launch and how the venture has defined them); what the key milestones and deliverables are; whether the venture has established the critical paths and dependencies; whether the venture understands the critical risks and has established contingency plans; what the team structure is and what the defined roles, accountabilities and responsibilities of the teams are; whether the venture has identified and resourced the appropriate skills; whether the venture has the appropriate program and project management structure and tools in place; how the venture is managing and measuring the teams; who the key stakeholders are and what launch roles the venture has defined for them; what the governance and decision-making model is for launch; and what communication activities are needed (e.g., external and/or internal with partners and/or alliances).

Key tasks that are accomplished when developing the launch plan include, for example, defining launch projects as aligned with first stage approach requirements; identifying launch project priorities; confirming dependencies and critical paths; prioritizing and timephasing projects into short-and mid-term time horizons; identifying interdependencies and/or prerequisite relationships and sequence projects; developing high-level project plans, including activities and milestones; identifying risks and mitigation actions; defining decision-making and escalation processes; developing and organizing project teams; defining program management office; and confirming communication plans.

Key deliverables that are created when developing the launch plan include, for example, milestones and critical paths, the launch priorities schedule, the communication plans, project profiles, the program management approach and the launch plan itself.

When launching the business (indicated at 34), the company effects a launch that ensures that investor, market and customer expectations are met, as this task and its objects are readily understood by one having ordinary skill in the art. Exemplary specific determinations that are made include whether the venture has designed the solution to meet necessary requirements; whether the venture has integrated all elements of the solution; whether the key assumptions supporting the launch requirements are still valid; whether the venture is delivering the right messages to the market and to target customers; whether the venture has ensured that the operations can handle the launch requirements and the projected initial growth; whether the venture has completed all necessary testing; whether the venture has ensured that all teams and/or individuals understand their roles and responsibilities; whether the venture is delivering the value proposition; whether the venture's partners and/or suppliers are ready for the launch and whether their processes and/or technologies are integrated; whether the venture is measuring and monitoring the right external and internal factors; whether the venture has appropriate contingency plans in place; and whether the venture has the resources necessary to operate, to address unexpected complications and to plan and build long-term (e.g., second stage approach) improvements.

Key tasks that are accomplished when launching the business include, for example, completing detailed planning; implementing and resourcing PMO and project teams; managing the program and budget; completing the detailed design; ensuring the quality of the design and deliverables; completing the build; managing partners, alliances and/or third parties; monitoring external and internal environments to ensure that the plan is still valid ensuring, solutions are integrated and designed to deliver required results; defining testing plan and launch readiness criteria; implementing testing and confirming launch readiness; confirming that the organizational structure is in place; managing market, investor and stakeholder expectations; and, of course, launching.

Key deliverables that are created when launching the business include, for example, the detailed design, the completed solution, and the business launch itself.

Preferably, performing the first stage approach further includes reaffirming an economic case for the business while developing the business launch plan. When reaffirming the economic case (indicated at 36), the company confirms the launch and operating budgets, the economics behind the business plan, and how long-term financial benefits will achieved, as these tasks and task objects are readily understood by one having ordinary skill in the art. Exemplary specific determinations that are made include what funding is available; what future finding must be obtained; what financial and/or operating results must be achieved to obtain future funding; what the overall launch investment is; what resource estimates and investments are required for each project; what the ongoing operating budget is; how the pricing strategy will deliver projected revenues; how revenue, profits and/or benefits can be quickly achieved to build momentum; how costs and benefits will be tracked; which KPIs will indicate success in achieving the benefits; how financial targets have been built into the launch and operating plans; how teams and/or individuals are being held accountable for financial results; and what sensitivities are key to achieving defined financial targets (e.g., revenue, cost and/or capital targets).

Key tasks that are accomplished when reaffirming the economic case include, for example, confirming the original market and business assumptions; confirming that the launch pricing strategy supports revenue projections; developing high-level cost estimates for each major project, including technology, process and organization estimates; confirming operating cost budgets; confirming that cash flow projections are in line with funding requirements and/or commitments; developing a value realization plan; developing tracking and control mechanisms; establishing escalation procedures; developing a KPI deployment approach and identifying KPI owners; and confirming exit criteria and options.

Key deliverables that are created when reaffirming the economic case include, for example, a refined business plan, project cost/benefit estimates, and a value realization plan.

Preferably, performing the first stage approach further includes developing a capability simulation demonstration for testing the first stage architecture while developing the architecture. When developing the capability simulation demonstration (indicated at 38), the company develops the demonstration as a dynamic model that describes how the architectures will operate, validates the customer experience, and predicts performance in a “proof of concept” environment, as these tasks and task objects are readily understood by one having ordinary skill in the art. With regard to the capability simulation, exemplary specific determinations that are made include whether the venture's architectures will perform as expected, how the venture's architectures will perform under different business events, how long the launch architecture will support the projected volumes and growth, what bottlenecks and constraints may limit performance, and which design alternative will deliver the greatest value. With regard to web-based screen demonstrations, exemplary specific determinations that are made include how the customer experience will actually look and feel, and whether the architecture will support this experience.

Key tasks that are accomplished when developing the capability simulation demonstration include, for example, collecting simulation data, developing web-based screen requirements, defining information and content requirements, defining the presentation format, defining the personalization look and feel, defining the screen hierarchy, developing a simulation model that is aligned with the architecture alternatives, running simulation scenarios, developing web-based screen demonstrations, and iterating as required.

Key deliverables that are created when developing the capability simulation demonstration include, for example, a capability simulation model, and web-based screen demonstrations (e.g., for customers and customer service representatives).

Preferably, performing the first stage approach further includes managing post-launch business operations. When managing the post-launch business operations (indicated at 40), the company focuses on key outcomes, capabilities and processes, employing specific management and organizational techniques to maximize efficiency, as these tasks and task objects are readily understood by one having ordinary skill in the art. Exemplary specific determinations that are made include whether the venture is maximizing its end-to-end efficiency, whether the venture is continually improving, whether the venture is performing as expected against key indicators, whether the venture is delivering the required customer experience, whether customers are behaving as expected, whether the venture is continuing to manage customer expectations, whether alliances and partners are operating as required, what immediate actions the venture can take to take advantage of and accelerate the venture's success, whether the venture is gathering the information necessary to make unresolved decisions and/or reduce uncertainties, whether the venture needs to accelerate and/or decelerate the second stage approach build, and how the market and/or competition has reacted.

Key tasks that are accomplished when managing the post-launch business operations include, for example, monitoring key performance indicators (e.g., internal and/or external); monitoring customer reactions and behaviors; gathering customer feedback and suggestions; gathering partner and supplier feedback and suggestions; reviewing competitive reactions; reviewing results and taking short-term actions as appropriate; reviewing and revising second stage approach growth and build plans; implementing processes and structures for addressing unexpected complications; assigning teams for issue resolution; communicating with the market, customers, employees and stakeholders; and implementing improvement processes and incentives.

Key deliverables that are created when managing the post-launch business operations include, for example, operating structures, key management processes, revised second stage approach plans, and a revised value realization plan.

When the company is, for example, an e-commerce start-up, the first stage approach can be effectively completed in a compressed timeframe and in partial concurrence in a manner illustrated in exemplary FIG. 4. More specifically, for example, reviewing the business strategy (indicated at 16) and defining the operating vision (indicated at 18) can be performed during a first week 42 of a first stage approach timeframe, developing the first stage operating strategy (indicated at 20) and developing the first stage priority (indicated at 22) can be performed during a second week 44 of the timeframe, developing the first stage architecture (indicated at 24) can be performed from the second week 44 to a fourth week 46 of the timeframe, developing the business launch plan (indicated at 32) can be performed from the fourth week 48 to a fifth week 50 of the timeframe, and launching the business (indicated at 34) can be performed after the fifth week (indicated by 52).

The second stage approach is adapted to mature the business and performing the second stage approach includes reviewing at least one result of performing the first stage approach; evaluating the first stage operating strategy in light of the result review; developing, based on the first stage operating strategy evaluation, a second stage operating strategy and at least one second stage priority; evaluating the first stage architecture in light of the second stage operating strategy; developing, based on the first stage architecture evaluation, at least one second stage architecture for implementing the second stage operating strategy to achieve the second stage priority; developing a plan for launching a second stage capability using the second stage architecture; and launching the capability.

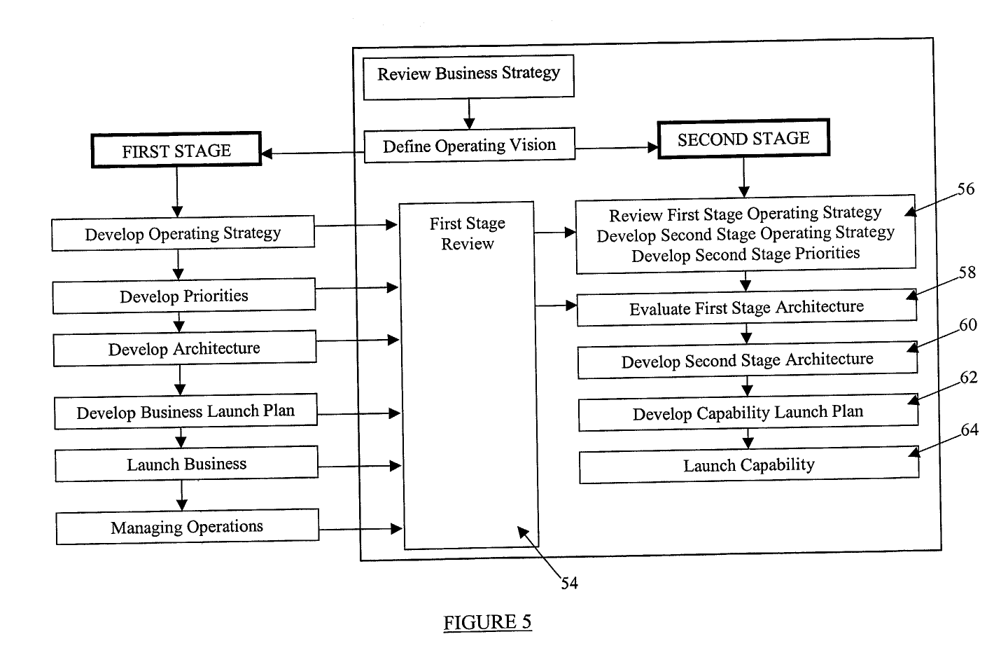

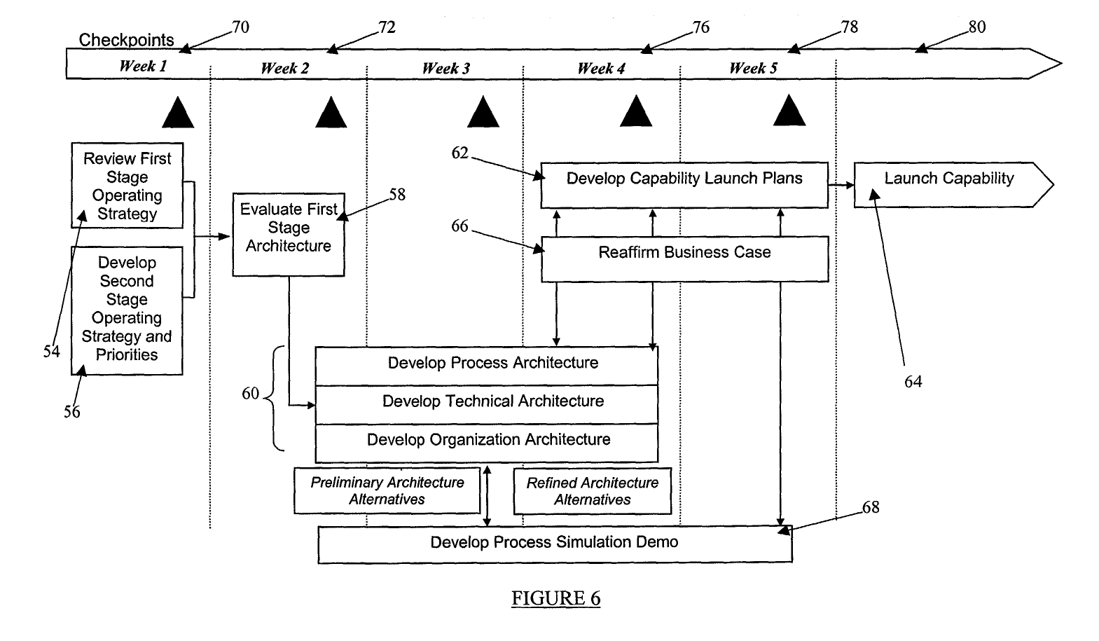

FIG. 5 illustrates an exemplary method of the invention highlighting a second stage approach, and FIG. 6 illustrates activities of the second stage approach within a second stage approach timeframe. When the company is, for example, an e-commerce start-up, these activities can be effectively performed in a manner illustrated in exemplary FIG. 5 and can be effectively completed in a compressed timeframe and in partial concurrence in a manner illustrated in exemplary FIG. 6.

When reviewing the result of performing the first stage approach (indicated at 54), the company continually monitors the critical external and internal factors that will impact the second stage approach activities, as these tasks and task objects are readily understood by one having ordinary skill in the art. With regard to markets and competitors, exemplary specific determinations that are made include whether the venture's business strategy is still appropriate, how the venture's competitive position has changed, what the venture's continued competitive advantage will be, and whether the venture has identified new alliances that it must develop. With regard to customers, exemplary specific determinations that are made include whether the venture has achieved its initial user, customer and revenue targets; whether the venture's customers have used the website as expected; how the venture's customers have reacted to the venture's value proposition, whether the venture has delivered its planned customer experience; how the venture's customer needs have changed and how they are expected to change; what it will take to attract and retain new customers (e.g., build long-term loyalty) and whether the venture needs to alter its product and/or service rollout plans. With regard to economic considerations, exemplary specific determinations that are made include what financial results the venture must deliver to satisfy the market, whether the venture's value proposition and associated revenue model is still valid, and whether the venture is on track to achieve its financial goals. With regard to operations, exemplary specific determinations that are made include, for example, whether the first stage approach architecture is performing as expected, and whether changes in second stage approach performance requirements and/or operating parameters are needed. With regard to general considerations, exemplary specific determinations that are made include, for example, whether the venture should continue.

Key tasks that are accomplished when reviewing the result include, for example, establishing executive ownership for the first stage approach review process, monitoring key external factors and analyzing results, confirming and/or refining original assumptions, confirming and/or refining the business strategy based on the result, confirming and/or refining the customer value proposition, confirming and/or refining product and service roll-out plans, reviewing the value proposition and its sensitivity to changes in market dynamics, reviewing and/or confirming the required financial results, reviewing existing alliance performance and future alliance needs, reviewing the first stage approach operating model and assessing the lessons learned, assessing the impact on the second stage approach operating strategy, and updating the value analysis plan and/or the business plan.

Key deliverables that are created when reviewing the result include, for example, a refined and/or updated business strategy, and a refined and/or updated business plan.

When evaluating the first stage operating strategy in light of the result review and developing, based on the first stage operating strategy evaluation, the second stage operating strategy and the second stage priority (collectively indicated at 56), the company redefines the venture's operating model, taking into account the maturing business strategy and the lessons learned from the launch, as this task and its objects are readily understood by one having ordinary skill in the art. Exemplary specific determinations that are made include what changes to the operating capabilities are needed to deliver a revised business strategy, a revised value proposition and/or revised financial targets; what operating capabilities must be demonstrated to the market and by when; whether the venture's end-to-end customer experience and relationship strategy is still valid; what operational lessons have been learned; whether the venture has confirmed and/or redefined the necessary operating performance requirements; what critical performance issues must be addressed in the second stage approach; whether the venture must revise its current operational arrangements with its partners; whether the venture's existing second stage approach web and/or infrastructure projects are still valid and whether they should continue or be stopped and/or revised; and whether the venture must revisit its initial outsourcing strategy.

Key tasks that are accomplished when evaluating the first stage operating strategy and developing the second stage operating strategy and the second stage priority include, for example, reviewing the results of the first stage approach review, confirming and/or refining the targeted customer experience and relationship, determining whether the operating strategy must change, confirming and/or refining the second stage approach operating principles, confirming and/or refining the second stage approach performance requirements, identifying failures to meet current target performance levels and performing root cause analyses, determining lessons learned from the first stage approach, evaluating second stage approach projects that have already been started, confirming and/or refining the sourcing strategy, and updating capability guiding principles and key characteristics.

Key deliverables that are created when evaluating the first stage operating strategy and developing the second stage operating strategy and the second stage priority include, for example, a refined customer experience description, a refined second stage approach operating strategy, refined second stage approach performance requirements, refined second stage approach capability guiding principles, and a refined alliance and/or sourcing strategy.

When evaluating the first stage architecture in light of the second stage operating strategy (indicated at 58), the company confirms the elements to be retained and the elements to be replaced and/or enhanced, as this task and its objects are readily understood by one having ordinary skill in the art. Exemplary specific determinations that are made include whether the original launch operating assumptions were valid, at what level the first stage approach was expected to perform, how well the first stage architecture met these performance levels, what components of the first stage architecture are not meeting expectations, what the root causes are for underperformance, what improvement requests have been made, what the implications are of the revised second stage approach requirements and/or guiding principles, which components of the launch architecture are not capable of meeting the revised second stage approach requirements, whether these components can be enhanced or must be replaced, whether there have been technology advances that suggest necessary changes to the planned second stage architecture, and what infrastructure decisions must be revised.

Key tasks that are accomplished when evaluating the first stage architecture include, for example, confirming revised capability performance requirements (e.g., KPIs and targets), reviewing first stage approach operating issues and/or lessons learned, reviewing existing second stage approach blueprints, determining whether website and/or customer interfaces meet requirements, determining whether the total first stage approach solution can be enhanced to deliver the revised second stage approach requirements, benchmarking and/or simulating the projected first stage approach potential performance against the second stage approach requirements, identifying first stage architecture components that should be retained, enhanced and/or replaced, updating the second stage architecture blueprint, and refining the second stage approach design and launch plan.

Key deliverables that are created when evaluating the first stage architecture include, for example, a first stage approach issue/root cause analysis, a refined first stage approach solution enhancement plan, and a refined second stage architecture blueprint.

When developing, based on the first stage architecture evaluation, the second stage architecture for implementing the second stage operating strategy to achieve the second stage priority (indicated at 60), the company defines the stable operating structure that will profitably meet a continually expanding set of requirements, as this task and its object are readily understood by one having ordinary skill in the art. The second stage architecture may be at least one of a business architecture and a component architecture, and the component architecture may be at least one of a process architecture, a technical architecture and an organization architecture. The nature of these architecture types has been described above in the discussion of the first stage approach.

Exemplary specific determinations that are made include how the second stage architecture will deliver every aspect of the defined customer experience; how the venture will ensure that relationships with third parties (e.g., partners and/or suppliers) operate as defined; how the business architecture will meet key measures (e.g., economic measures) for investors and/or stakeholders; whether the venture will be able to operate at acceptable profit levels; how the architecture will handle growth (e.g., whether the venture has contingency plans for unplanned volumes); how the venture has maximized its ability to change what it offers customers and the way it operates when necessary; whether the venture's processes, organization and technologies are integrated across all capabilities; what components of the first stage architecture should be retained and whether the venture has maximized the first stage approach investment; whether all second stage architecture replacement decisions have been justified; what volumes and/or expectations the second stage architecture can handle; whether the second stage architecture can deliver the desired performance levels; whether the venture has incorporated the lessons learned and improvement opportunities from the first stage approach; and how the original second stage architecture assumptions and/or components have changed since launch.

Key tasks that are accomplished when developing the second stage architecture include, for example, confirming the second stage architecture blueprint and requirements, defining any required architecture changes, defining and/or refining the second stage business capability designs and blueprints, refining the website design and capabilities, defining and/or refining cross-capability architectures (e.g., end-to-end processes, technologies, organization and/or facilities), defining and/or refining alliance and/or supplier requirements, defining and/or refining outsourcing requirements, confirming the business performance model, confirming that the second stage architecture components will meet performance requirements (e.g., by simulation), and reviewing critical assumptions and evaluating whether the architecture can be changed if assumptions and/or requirements change.

Key deliverables that are created when developing the second stage architecture include, for example, business architecture and/or capability blueprints, a process architecture, a technology architecture and an organization architecture.

When developing a plan for launching a second stage capability using the second stage architecture (indicated at 62), the company takes account of current activities to address any performance problems resulting from the first stage approach activities, as this task and its object are readily understood by one having ordinary skill in the art. With regard to changing a program, exemplary specific determinations that are made include what the key projects are and what the release strategy is; what the key milestones and deliverables are; what are the defined roles, accountabilities and responsibilities for the teams are; whether the venture has established the project sequencing, dependencies, and critical paths; whether the venture understands the critical risks and has established contingency plans; how the venture resolves conflicts and resource constraints; how the venture will implement the second stage approach while maintaining acceptable operation levels; and how the venture will insulate customers from disruption. With regard to changing a management plan, exemplary specific determinations that are made include who will own the initiative, how the venture will support stakeholders through the change process, and whether the venture has the proper communication and other change management tools in place.

Key tasks that are accomplished when developing the capability launch plan include, for example, reviewing the second stage business architecture and developing a project definition; evaluating existing first stage approach improvement projects and second stage approach design and/or build projects; stopping and/or refining existing projects as needed; confirming dependencies and critical paths; prioritizing and timephasing projects into short- and mid-term time horizons; identifying interdependencies and/or prerequisite relationships and sequence projects; developing high-level project plans, including activities and milestones; identifying risks and mitigation actions; defining decision-making and escalation processes; developing and organizing project teams; defining program management office; and confirming communications plans.

Key deliverables that are created when developing the capability launch plan include, for example, a transition plan, milestones and critical paths, a transition priorities schedule, a communication plan, project profiles, and a program management approach.

When launching the capability (indicated at 64), the company uses a business integration methodology that is tailored to the venture, as this task and its object are readily understood by one having ordinary skill in the art. Exemplary specific determinations that are made include whether the venture has designed the solution to meet necessary requirements; whether the venture has integrated all elements of the solution; whether the key assumptions supporting growth and second stage approach requirements are still valid; whether the venture is continuing to deliver the right messages to the market and to target customers; whether the venture has ensured that the operations can handle growth in volume, service and/or customer expectations; whether the venture has completed all necessary testing; whether the venture has ensured that all teams and/or individuals understand their roles and responsibilities; whether the venture is delivering the value proposition; whether the venture's partners and/or suppliers are ready for the second stage approach and whether their processes and/or technologies have been integrated; whether the venture has appropriate contingency plans in place; whether the venture is building the ownership and support necessary for a successful transition; whether the venture is managing external and internal stakeholder expectations; and whether the venture is continued to incorporate lessons learned from the first stage approach review into the second stage approach design and build.

Key tasks that are accomplished when launching the capability include, for example, completing detailed planning; implementing and resourcing PMO and project teams; managing program and budgets; completing the detailed design; ensuring the quality of design and deliverables; completing the build; managing partners, alliances and/or third parties; monitoring external and internal environments to ensure that the business plan is still valid; ensuring that solutions are integrated and designed to deliver that required results; defining testing plan and launch readiness criteria; implementing the testing and confirming launch readiness; confirming that the necessary organization is in place; and transitioning to the second stage approach.

Key deliverables that are created when launching the capability include, for example, a detailed design, a completed solution, and the launch itself.

Preferably, performing the second stage approach further includes reaffirming an economic case for the business while developing the capability launch plan. When reaffirming the economic case (indicated at 66), the company defines the economic case for the capability launch plan and provides a value realization plan to validate that the benefits will be achieved, as these tasks and task objects are readily understood by one having ordinary skill in the art. Exemplary specific determinations that are made include whether the original economic case assumptions from the first stage approach hold true; whether the existing revenue model will deliver the required revenue levels; what investment is required for each project; what benefits are associated with each project; how the benefits can be quickly achieved to build momentum; what resource estimates are required to implement the transition plans; how costs and benefits will be tracked; how benefits realization will be planned into the change program; which KPIs will indicate success in achieving the benefits; whether the business has sufficient funding to cover projected costs, plus contingencies; and what fallback funding opportunities are in place if assumptions and projections are not met.

Key tasks that are accomplished when reaffirming the economic case include, for example, confirming that the original market and business assumptions are valid; confirming that the launch pricing strategy supports the economic case revenue projections; developing high-level cost estimates for each major project, including technology, process and organization estimates; confirming operating cost budgets; confirming that cash flow projections are in line with funding requirements and/or commitments; developing a value realization plan, developing tracking and control mechanisms; establishing escalation procedures; developing a KPI deployment approach and identifying KPI owners; and confirming exit criteria and options.

Key deliverables that are created when reaffirming the economic case include, for example, a refined business plan, project cost/benefit estimates and a value realization plan.

Preferably, performing the second stage approach further includes developing a process simulation demonstration for testing the second stage architecture while developing the architecture. When developing the process simulation demonstration (indicated in at 68), the company refines the legacy attributes and provides a “proof of concept” for new architectures that are required to replace disposable solutions developed during the first stage approach, as these tasks and task objects are readily understood by one having ordinary skill in the art. Exemplary specific determinations that are made include whether the venture has identified those processes that require simulation (e.g., underperforming legacy architectures and/or evolutionary architectures), whether the venture's architectures perform as expected, how the venture's architectures will perform under different business events, what bottlenecks and constraints may limit performance, and which design alternative will deliver the greatest value.

Key tasks that are accomplished when developing the process simulation demonstration include, for example, collecting simulation data, developing a simulation model aligned with architecture alternatives, developing a current state simulation model for legacy architectures, identifying bottlenecks, developing short-term improvement opportunities, developing to-be simulation models that are aligned with architecture alternatives, and iterating as required.

Key deliverables that are created when developing the process simulation demonstration include, for example, a capability simulation model.

When the company is, for example, an e-commerce start-up, the second stage approach can be effectively completed in a compressed timeframe and in partial concurrence in a manner illustrated in exemplary FIG. 6. More specifically, for example, reviewing the result (indicated at 54), evaluating the first stage operating strategy, and developing the second stage operating strategy and the second stage priority (indicated at 56) can be performed during a first week 70 of a second stage approach timeframe; evaluating the first stage architecture (indicated at 58) can be performed during a second week 72 of the timeframe; developing the second stage architecture (indicated at 60) can be performed from the second week 72 to a fourth week 76 of the timeframe; developing the capability launch plan (indicated at 62) can be performed from the fourth week 76 to a fifth week 78 of the timeframe; and launching the capability (indicated at 64) can be performed after the fifth week (indicated by 80).

Certain of the first stage approach activities can be performed while certain of the second stage approach activities are performed. For example, first stage approach activities that are performed during the fourth and fifth weeks of the first stage approach timeframe can be performed concurrent with second stage approach activities that are performed during the first and second weeks of the second stage approach timeframe.

In yet another aspect, the second state approach is adapted to guide the business to an initial public offering readiness state and performing the second stage approach includes defining at least one operational performance target that when achieved by the business will evidence an IPO readiness state of the business; reviewing at least one operation of the business in light of the target; determining, based on the business operation review, a second stage operating strategy that when followed will achieve the target; evaluating the first stage architecture in light of the second stage operating strategy; developing, based on the evaluation, at least one second stage architecture for implementing the second stage operating strategy to achieve the target; developing a plan for launching a second stage capability using the second stage architecture; and launching the capability.

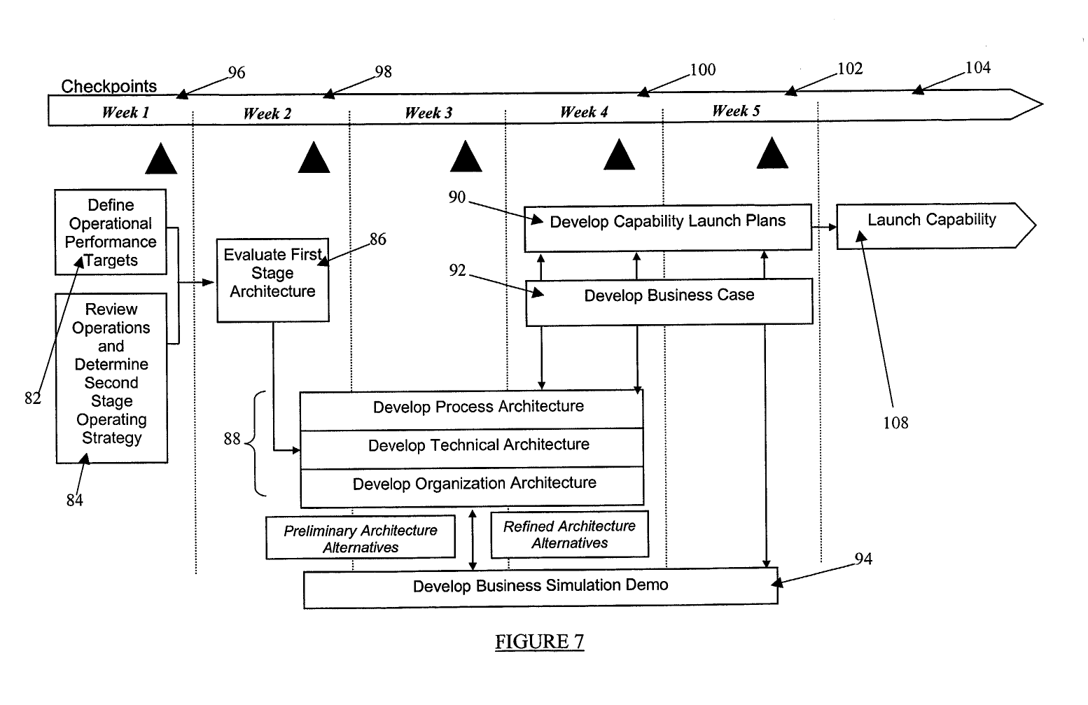

FIG. 7 illustrates activities of an alternate second stage approach of a method of the invention within an alternate second stage approach timeframe. When the company is, for example, an e-commerce start-up, these activities can be effectively completed in a compressed timeframe and in partial concurrence in a manner illustrated in exemplary FIG. 7.

When defining at least one operational performance target that when achieved by the business will evidence an IPO readiness state of the business (indicated at 82), the company ensures that the business and financial targets for the IPO are defined and translated into measurable operational performance objectives, as these tasks and task objects are readily understood by one having ordinary skill in the art. Exemplary specific determinations that are made include what financial and/or other performance targets must be hit for a successful IPO; what key financial levers drive value and which have the greatest impact on value creation; whether current projections and targets will deliver the required IPO performance and if not, what must change; what the key indicators of value are and what the key operational drivers of those indicators are; what capabilities and/or processes impact those drivers; what capability and/or process performance metrics and targets are needed to deliver IPO performance; what the current performance levels are; what the current and anticipated volumes are; whether the venture will need alternative funding if the IPO is delayed; and whether there is a fallback financing strategy if the IPO is delayed.

Key tasks that are accomplished when defining the target include, for example, reviewing financial projections, performing value analyses to identify key financial and operational value drivers, baselining current performance levels, defining metrics and targets needed for design processes, baselining current volumes, and determining target volume levels.

Key deliverables that are created when defining the target include, for example, KPIs and current levels of performance, targeted performance levels, current and planned volume levels, and key value drivers and value analyses.

When reviewing the operation of the business in light of the target and determining, based on the business operation review, a second stage operating strategy that when followed will achieve the target (collectively indicated at 84), the company reviews the existing operations and planned enhancements against the performance targets that are defined to support the IPO, as this task and its objects are readily understood by one having ordinary skill in the art. Exemplary specific determinations that are made include what breadth of services will be offered, what the source of competitive advantage will be, what the key assumptions are behind the strategy, what value proposition is offered to the customer, what the marketing strategy is, what customer segments and geographical markets are targeted, what the desired customer experience is, what capabilities and performance levels are required to deliver the value proposition to the customers, how these capabilities must perform and/or what results must they achieve, how these capabilities operate currently, whether planned future expansion and/or improvements will deliver the necessary performance, where operations will fall short, what corrective actions must be taken, and whether outsourcing is a possible solution.

Key tasks that are accomplished when reviewing the business operation and determining the second stage operating strategy include, for example, reviewing the IPO plan and expectations; confirming IPO requirements; reviewing the business strategy and the business plan; reviewing planned products, volumes and/or geographies; listing critical strategy assumptions; reviewing the economic case and underlying assumptions; baselining current practices, processes, technologies and organization and planned near-term changes; developing a customer value proposition; and defining critical capabilities.

Key deliverables that are created when reviewing the business operation and determining the second stage operating strategy include, for example, a business capability map; a customer experience description; a description and/or diagram of current operating practices; a list of current capacity inhibitors; and a list of business objectives, guiding principles, end state features and characteristics that are needed to achieve the objectives.

When evaluating the first stage architecture in light of the second stage operating strategy and developing, based on the evaluation, the second stage architecture for implementing the second stage operating strategy to achieve the target (indicated at 86 and 88), the company refines the planned business architecture to deliver the performance required for a successful IPO, as this task and its object are readily understood by one having ordinary skill in the art. The second stage architecture in this aspect can be at least one of a business architecture and a component architecture, and the component architecture can be at least one of a process architecture, a technical architecture and an organization architecture. The nature of these architecture types has been described above in the discussion of the first stage approach.

Exemplary specific determinations that are made include how the second stage architecture will deliver aspects of the defined customer experience; how the venture will ensure that relationships with third parties (e.g., partners and/or suppliers) will operate as defined; how the second stage architecture will meet key measures for investors and/or stakeholders; whether the venture will be able to operate at acceptable profit levels; how the second stage architecture will handle growth (e.g., whether the venture has contingency plans for unexpected volumes); how the venture has maximized its ability to change what it offers customers and the way it operates when necessary; whether processes, organization and technologies are integrated across all capabilities; what components of the first stage architecture have been retained and whether the venture has maximized the first stage approach investment; whether all second stage replacement decisions have been justified; what volumes and/or expectations the second stage architecture can handle; whether the second stage architecture can deliver the desired performance levels; whether the venture has incorporated the lessons learned and improvement opportunities from the first stage approach; and how the original second stage architecture assumptions and/or components have changed since launch.

Key tasks that are accomplished when evaluating the first stage architecture and developing the second stage architecture include, for example, confirming IPO architecture blueprint and requirements, defining architectural changes that will be required to deliver IPO performance, defining and refining business capability designs and blueprints, refining website design and capabilities, defining and/or refining cross-capability architectures (e.g., end-to-end processes, technologies, organization and/or facilities), defining and/or refining alliance and/or supplier requirements, defining and/or refining outsourcing requirements, confirming the business performance model, confirming that the second stage architecture components will meet performance requirements (e.g., by simulation); and reviewing critical assumptions and evaluating whether the architecture can be changed if assumptions and/or requirements change.

Key deliverables that are created when evaluating the first stage architecture and developing the second stage architecture include, for example, a business architecture, a process architecture, a technology architecture, and an organization architecture.

When developing a plan for launching a second stage capability using the second stage architecture (indicated at 90), the company creates the plan according to priorities identified to achieve IPO level performance, as this task and its object are readily understood by one having ordinary skill in the art. With regard to changing a program, exemplary specific determinations that are made include what the key projects are and what the release strategy is; what the key milestones and deliverables are; what the defined roles, accountabilities and responsibilities for the team are; whether the venture has established the project sequencing, dependencies and critical paths; whether the venture understands the critical risks and has established contingency plans; how the venture will resolve conflicts and resource constraints; how the venture will implement the second stage approach while maintaining acceptable operation levels; and how the venture will insulate customers from disruption. With regard to changing a management plan, exemplary specific determinations that are made include who will own the initiative, how the venture will support stakeholders through the change process, and whether the venture has the proper communication and other change management tools in place.

Key tasks that are accomplished when developing the capability launch plan include, for example, reviewing the IPO business architecture and developing a project definition; evaluating existing first stage approach improvement projects and IPO design and/or build projects; stopping and/or refining existing projects as needed; confirming dependencies and critical paths; prioritizing and timephasing projects into short- and midterm time horizons; identifying interdependencies and/or prerequisite relationships and sequence projects; developing high-level project plans, including activities and milestones; identifying risks and mitigation actions; defining the decision making and escalation process; developing and organizing project teams; defining program management office; and confirming communication plans.

Key deliverables that are created when developing the capability launch plan include, for example, a transition plan, milestones and critical paths, a transition priorities schedule, a communication plan, project profiles, and a program management approach.

Preferably, performing the second stage approach in this aspect further includes reaffirming an economic case for the business while developing the capability launch plan. When reaffirming the economic case (indicated 92) the company ensures that revenue and cost measures are identified, tracked and managed, as this task and its objects are readily understood by one having ordinary skill in the art. Exemplary specific determinations that are made include whether the original economic case assumptions from the first stage approach hold true; whether the existing revenue model will deliver the required revenue levels; what investment is required for each project; what benefits are associated with each project; how benefits can be quickly achieved to build momentum; what resource estimates are required to implement the transition plans; how costs and benefits will be tracked; how benefits realization will be planned into the change program; which KPIs will indicate success in achieving the benefits; whether the business has sufficient finding to cover projected costs, plus contingencies; and what fallback funding opportunities are in place if assumptions and projections are not met.

Key tasks that are accomplished when reaffirming the economic case include, for example, confirming that original market and business assumptions are valid; confirming that the launch pricing strategy supports the economic case revenue projections; developing high-level cost estimates for each major project, including technology, process and organization estimates; confirming operating cost budgets; confirming that cash flow projections are in line with funding requirements and/or commitments; developing a value realization plan; developing tracking and control mechanisms; establishing escalation procedures; developing a KPIs deployment approach and identifying KPI owners; and confirming exit criteria and options.

Key deliverables that are created when reaffirming the economic case include, for example, a refined business plan, project cost/benefit estimates, and a value realization plan.

Preferably, performing the second stage approach in this aspect further includes developing a business simulation demonstration for testing the second stage architecture while developing the architecture. When developing the business simulation demonstration (indicated 94), the company refines the legacy attributes and provides a “proof of concept” for new architectures that are required to replace disposable solutions developed during the first stage approach, as these tasks and task objects are readily understood by one having ordinary skill in the art. Exemplary specific determinations that are made include whether the venture has identified those processes that require simulation (e.g., underperforming legacy architectures and/or evolutionary architectures); whether the venture's architectures will perform as expected, how the venture's architectures will perform under different business events; what bottlenecks and constraints may limit performance; and which design alternative will deliver the greatest value.

Key tasks that are accomplished when developing the business simulation demonstration include, for example, collecting simulation data, developing a simulation model aligned with architecture alternatives, developing a current state simulation model for legacy architectures, identifying bottlenecks, developing short term improvement opportunities, developing to-be simulation models that are aligned with architecture alternatives, and iterating as required.

Key deliverables that are created when developing the business simulation demonstration include, for example, a capability simulation model.

When the company is, for example, an e-commerce start-up, the second stage approach in this aspect can be effectively completed in a compressed timeframe and in partial concurrence in a manner illustrated in exemplary FIG. 7. More specifically, for example, defining the target (indicated at 82) and reviewing the business operation and determining the second stage operating strategy (collectively indicated at 84) can be performed during a first week 96 of a second stage approach timeframe; evaluating the first stage architecture and developing the second stage architecture (indicated at 86 and 88) can be performed from a second week 98 of the timeframe to a fourth week 102 of the timeframe; developing the capability launch plan (indicated at 90) can be performed from the fourth week 102 to a fifth week 104 of the timeframe; and launching the capability (indicated at 108) can be performed after the fifth week (indicated by 106).

Certain of the first stage approach activities in this aspect can be performed while certain of the second stage approach activities are performed. For example, first stage approach activities that are performed during the fourth and fifth weeks of the first stage approach timeframe can be performed concurrent with second stage approach activities that are performed during the first and second weeks of the second stage approach timeframe.

Those skilled in the art will recognize that the method of the invention has many applications, and that the invention is not limited to the representative embodiments disclosed herein. The scope of the invention is only limited by that of the claims appended hereto.

What is claimed is:

1. A method for guiding a business after an initial funding state, comprising:
a) performing a first stage approach for launching the business; and
b) performing a second stage approach for at least one of maturing the business and guiding the business to an initial public offering readiness state.

2. The method of claim 1, wherein performing the first stage approach comprises:
a) reviewing a business strategy;
b) defining an operating vision;
c) developing a first stage operating strategy;
d) developing at least one first stage priority;
e) developing at least one first stage architecture for implementing the first stage strategy to achieve the first stage priority;
f) developing a plan for launching the business using the first stage architecture; and
g) launching the business.

3. The method of claim 2, wherein the architecture is at least one of a business architecture and a component architecture.

4. The method of claim 3, wherein the component architecture is at least one of a process architecture, a technical architecture and an organization architecture.

5. The method of claim 2, wherein performing the first stage approach further comprises reaffirming an economic case for the business while developing the launch plan.

6. The method of claim 2, wherein performing the first stage approach further comprises developing a capability simulation demonstration for testing the architecture while developing the architecture.

7. The method of claim 2, wherein performing the first stage approach further comprises managing post-launch business operations.

8. The method of claim 2, wherein:
a) reviewing the business strategy and defining the operating vision are performed during a first week of a first stage approach timeframe;
b) developing the first stage operating strategy and developing the first stage priority are performed during a second week of the timeframe;
c) developing the architecture is performed from the second week to a fourth week of the timeframe;
d) developing the launch plan is performed from the fourth week to a fifth week of the timeframe; and
e) launching the business is performed after the fifth week.

9. The method of claim 2, wherein:
a) the second stage approach is adapted to mature the business; and
b) performing the second stage approach comprises:
i) reviewing at least one result of performing the first stage approach;
ii) evaluating the first stage operating strategy in light of the result review;
iii) developing, based on the first stage operating strategy evaluation, a second stage operating strategy and at least one second stage priority;
iv) evaluating the first stage architecture in light of the second stage operating strategy;
v) developing, based on the first stage architecture evaluation, at least one second stage architecture for implementing the second stage operating strategy to achieve the second stage priority;
vi) developing a plan for launching a second stage capability using the second stage architecture; and
vii) launching the capability.

10. The method of claim 9, wherein the second stage architecture is at least one of a business architecture and a component architecture.

11. The method of claim 10, wherein the component architecture is at least one of a process architecture, a technical architecture and an organization architecture.

12. The method of claim 9, wherein performing the second stage approach further comprises reaffirming an economic case for the business while developing the capability launch plan.

13. The method of claim 9, wherein performing the second stage approach further comprises developing a process simulation demonstration for testing the second stage architecture while developing the second stage architecture.

14. The method of claim 9, wherein:
a) reviewing the result, evaluating the first stage operating strategy, and developing the second stage operating strategy and the second stage priority are performed during a first week of a second stage approach timeframe;
b) evaluating the first stage architecture is performed during a second week of the timeframe;
c) developing the second stage architecture is performed from the second week to a fourth week of the timeframe;
d) developing the capability launch plan is performed from the fourth week to a fifth week of the timeframe; and
e) launching the capability is performed after the fifth week.

15. The method of claim 2, wherein:
a) the second stage approach is adapted to guide the business to an initial public offering readiness state; and
b) performing the second stage approach comprises:
i) defining at least one operational performance target that when achieved by the business will evidence an initial public offering readiness state of the business;
ii) reviewing at least one operation of the business in light of the target;
iii) determining, based on the business operation review, a second stage operating strategy that when followed will achieve the target;
iv) evaluating the first stage architecture in light of the second stage operating strategy;
v) developing, based on the evaluation, at least one second stage architecture for implementing the second stage operating strategy to achieve the target;
vi) developing a plan for launching a second stage capability using the second stage architecture; and
vii) launching the capability.

16. The method of claim 15, wherein the second stage architecture is at least one of a business architecture and a component architecture.

17. The method of claim 16, wherein the component architecture is at least one of a process architecture, a technical architecture and an organization architecture.

18. The method of claim 15, wherein performing the second stage approach further comprises reaffirming an economic case for the business while developing the capability launch plan.

19. The method of claim 15, wherein performing the second stage approach further comprises developing a business simulation demonstration for testing the second stage architecture while developing the second stage architecture.

20. The method of claim 15, wherein:
a) defining the target, reviewing the business operation, and determining the second stage operating strategy are performed during a first week of a second stage approach timeframe;
b) evaluating the first stage architecture is performed during a second week of the timeframe;
c) developing the second stage architecture is performed from the second week to a fourth week of the timeframe;
d) developing the capability launch plan is performed from the fourth week to a fifth week of the timeframe; and
e) launching the capability is performed after the fifth week.
